(19) United States
(12) Patent Application Publication
(10) Pub. No.: US 2017/0122621 A1
(43) Pub. Date: May 4, 2017

(54) HEAT RECEIVER TUBE, METHOD FOR MANUFACTURING THE HEAT RECEIVER TUBE, SOLAR COLLECTOR WITH THE HEAT RECEIVER TUBE AND METHOD FOR PRODUCING ELECTRICITY BY USING THE SOLAR COLLECTOR

(71) Applicant: SIEMENS CONCENTRATED SOLAR POWER LTD., ROSH HA'AYIN (IL)

(72) Inventor: SHMULIK KLAPWALD, JERUSALEM (IL)

(21) Appl. No.: 15/336,892

(22) Filed: Oct. 28, 2016

(30) Foreign Application Priority Data
Nov. 2, 2015 (EP) 15192560.9

(51) Int. Cl. F24J 2/05; B23P 15/26

(52) U.S. Cl. CPC F24J 2/055; B23P 15/26

(57) ABSTRACT

A heat receiver tube for absorbing solar energy and for transferring absorbed solar energy to a heat transfer fluid which can be located inside of at least one core tube of the heat receiver tube is provided. The core tube includes a core tube surface with at least one solar energy absorptive coating for absorbing solar radiation. The core tube is enveloped by at least one enveloping tube. The enveloping tube includes at least one enveloping tube wall which is at least partly transparent for the solar radiation. The enveloping tube wall includes at least one inner enveloping tube surface. The core tube and the enveloping tube are coaxially arranged to each other such that an inner heat receiver tube space is formed which is bordered by the core tube surface and the inner enveloping tube surface.

### CROSS-REFERENCE TO RELATED APPLICATIONS

This application claims priority European application No. 15192560.9 having a filing date of Nov. 2, 2015, the entire contents of which are hereby incorporated by reference.

### FIELD OF TECHNOLOGY

This following relates to a heat receiver tube, a method for manufacturing the heat receiver tube, a solar collector with the heat receiver tube and a method for producing electricity by using of the solar collector.

### BACKGROUND

A sun energy collecting unit (solar collector) of a sun field power plant based on the concentrated solar power technique is for instance a solar collector with a parabolic mirror and a heat receiver tube. The heat receiver tube is arranged in a focal line of a solar radiation (sunlight) reflecting surface of the mirror. By the solar radiation reflecting surface sunlight is collected and focused to the heat receiver tube.

The heat receiver tube comprises a core tube (inner tube, e.g. made of stainless steel) which is filled with a heat transfer fluid, e.g. a thermo-oil or molten salt. With the aid of a solar radiation absorptive coating of the core tube the heat receiver tube absorbs energy from the sun. Energy from the sun is efficiently coupled into the heat transfer fluid. Solar energy is converted into thermal energy.

In order to minimize a loss of thermal energy, the heat receiver tube comprises an encapsulation with an enveloping tube. The enveloping tube envelops the core tube.

For instance, the enveloping tube is a glass tube. This enveloping tube is at least partly transparent for solar radiation. So, solar radiation can impinge the solar radiation absorptive coating of the core tube.

The core tube and the enveloping tube are coaxially arranged to each other resulting in an inner space of the heat receiver tube which is bordered by a core tube surface of the core tube and by an inner enveloping tube surface of an enveloping tube wall of the enveloping tube.

The inner space of the heat receiver tube between the inner tube and the enveloping tube is evacuated in order to minimize convection and hence in order to minimize a thermal loss of the heat receiver tube. The inner heat receiver tube space is a vacuum chamber.

One problem is a degradation of the heat transfer fluid during operation for years. By the degradation Hydrogen (H₂) results. This Hydrogen permeates through the stainless steel wall of the core tube into the evacuated inner space of the heat transfer tube. The result is a collapse of the vacuum of the inners space of the heat receiver tube and hence an increase of the thermal loss of the heat receiver tube.

### SUMMARY

An aspect relates to ensuring low thermal loss during the operation of a heat receiver tube.

Further aspects are the providing of a method for manufacturing the heat receiver tube, a solar collector with the heat receiver tube and a method for producing electricity by using the solar collector.

With embodiments of the invention a heat receiver tube for absorbing solar energy and for transferring absorbed solar energy to a heat transfer fluid which can be located inside of at least one core tube of the heat receiver tube is provided. The core tube comprises a core tube surface with at least one solar energy absorptive coating for absorbing solar radiation. The core tube is enveloped by at least one enveloping tube. The enveloping tube comprises at least one enveloping tube wall which is at least partly transparent for the solar radiation. The enveloping tube wall comprises at least one inner enveloping tube surface. The core tube and the enveloping tube are coaxially arranged to each other such that an inner heat receiver tube space is formed which is bordered by the core tube surface and the inner enveloping tube surface. The heat receiver tube comprises at least one inlet port for pouring in of at least one inert gas into the inner heat receiver tube space. In a preferred embodiment, the inlet port comprises an inlet port dimension which is selected from the range between 1 mm and 20 mm and preferably selected from the range between 2 mm and 10 mm.

For instance, the inner core tube comprises a core tube wall which is made of stainless steel. The enveloping tube which is transparent for the sunlight (transmission for specific wavelengths more the 90%) is arranged coaxially around the inner core tube of the heat receiver tube. The enveloping tube is preferably made of glass. The enveloping tube wall comprises glass. But other transparent materials are possible, too.

The core tube surface and the inner enveloping tube surface are preferably oppositely arranged to each other. The result is a vacuum chamber.

In a preferred embodiment, the heat receiver tube comprises least one dimension adapting device with a flexible adapting device wall for compensation of a thermally induced change of at least one dimension of the heat receiver tube. Preferably, the dimension adapting device comprises bellows and the flexible adapting device wall comprises a bellows wall. The bellows are preferably arranged at a front side of the heat receiver tube.

In a preferred embodiment, the enveloping tube and the dimension adapting device are covered by at least one heat receiver tube skirt with at least one heat receiver tube skirt wall.

In a preferred embodiment, the flexible adapting device wall and/or the heat receiver tube skirt wall comprise at least one metal. Preferably, these walls are made of metal, for instance stainless steel. Metal has the advantage that it is resistant to high temperatures. In addition, metal is quite flexible (in comparison to other materials like ceramics)

The inlet port or a plurality of inlet ports can be arranged at different locations of the heat receiver tube. In a preferred embodiment, the enveloping tube wall and/or the bellows wall and/or the heat receiver tube skirt wall comprise the inlet port.

In addition, a method for manufacturing a heat receiver tube with following steps is provided: a) providing of at least one precursor tube of at least one heat receiver tube and b) arranging of at least one inlet port at the heat receiver tube for pouring in of at least one gas into the inner heat receiver tube space of the heat receiver tube.

Moreover, a solar collector is provided which comprises at least one mirror having a solar radiation reflecting mirror surface for directing the solar radiation to a focal line of the solar radiation reflecting mirror surface and at least one heat receiver tube which is arranged in the focal line of the solar radiation reflecting mirror surface. Preferably, the mirror is a parabolic mirror or a Fresnel mirror. The mirror is a parabolic mirror with a parabolic shaped solar radiation reflecting mirror surface. Alternatively the mirror is a Fresnel mirror. Thereby it is not necessary, that the heat receiver tube is exactly located in the focal line of the mirror. Aberrations from an exact arrangement in the focal line are possible, too.

In addition, a method for producing electricity by using the solar collector in a solar thermal power plant for converting solar radiation into electrical energy, wherein an absorbing of the solar radiation is carried out with the aid of the solar collector.

Preferably, after the arranging of the inlet port at the receiver tube a pouring of the inert gas into the heat receiver tube space though the inlet port is carried out. The result is a heat receiver tube wherein the inner tube space comprises the inert gas. In a preferred embodiment the inert gas is at least one noble gas which selected from the group consisting of Krypton and Xenon. Other gases or mixtures of different gasses are possible, too.

In a preferred embodiment, a partial pressure of the inert gas in the inner heat receiver tube space is selected from the range between 5 mbar and 300 mbar and preferably between 100 mbar and 200 mbar. For instance, the inner space of the heat receiver tube is filled with Xe with a partial pressure of about 150 mbar.

In order to keep the inert gas in the inner space it is necessary to seal the inlet port after the filling (pouring in). So, in a preferred embodiment, after the pouring of the inert gas though the inlet port a sealing of the inlet port is carried out. With the aid of the sealing the loss of inert gas is avoided. Inert gas doesn't leave to the environment of the heat receiver tube. The sealing is advantageous for an inlet port which is arranged in the enveloping tube made of glass. Preferably, the sealing is carried out with the aid of a sealing. For instance, the sealing comprises a sealing ring. The sealing ring is preferably made of elastomeric sealing material.

For the introduction of the inlet port, there are different possibilities. Advantageous is the drilling of a hole. Therefore, in a preferred embodiment, the arranging of the inlet port comprises a drilling of a hole into at least one of the walls of the heat receiver tube. Preferably, the drilling comprises a laser drilling.

Finally a use of the solar collector in a solar thermal power plant for converting solar energy into electrical energy is disclosed. Thereby an absorbing of the sunlight energy is carried out with the aid of the solar collector.

Solar radiation is converted into thermal energy of a heat transfer fluid which is located in the core tube. The heat transfer fluid is a thermo-oil or a molten salt. Via a heat exchanger thermal energy of the heat transfer fluid is used to produce steam. This steam drives a turbine which is connected to a generator. The generator produces current.

One specific advantage of embodiments of the invention has to be noted: With the aid of embodiments of the invention it is possible to maintain proper thermal characteristics of the heat receiver tube. It is not necessary to exchange the heat receiver tube after a couple of years of operation.

### BRIEF DESCRIPTION

Some of the embodiments will be described in detail, with reference to the following figures, wherein like designations denote like members, wherein:

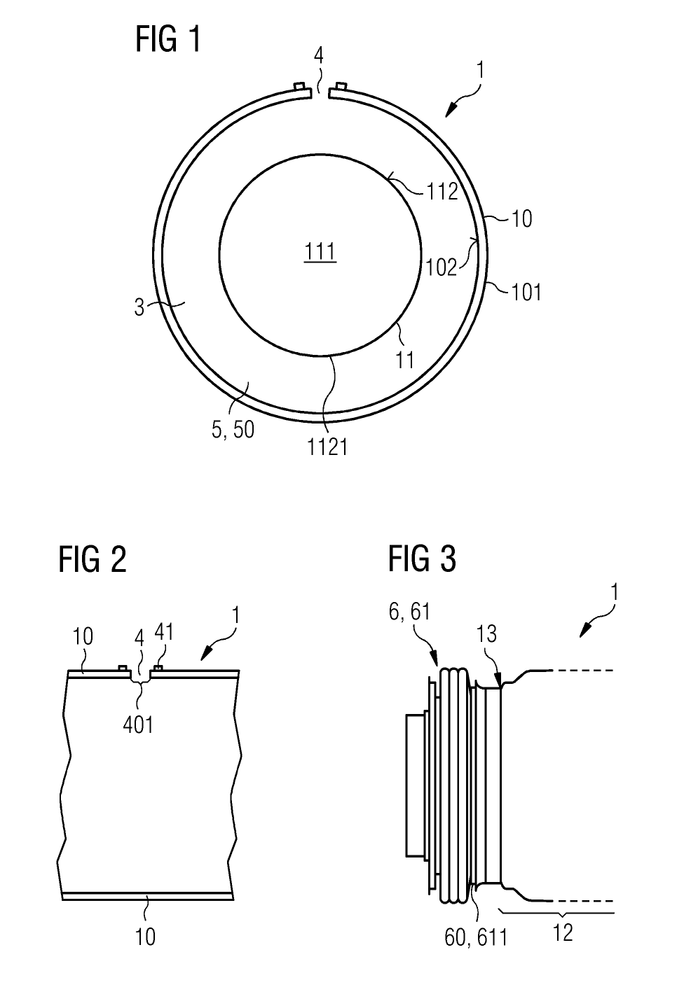

FIG. 1 shows cross sections of a heat receiver tube;

FIG. 2 shows a cross section perpendicular to FIG. 1;

FIG. 3 shows a part of the heat receiver tube of FIG. 1;

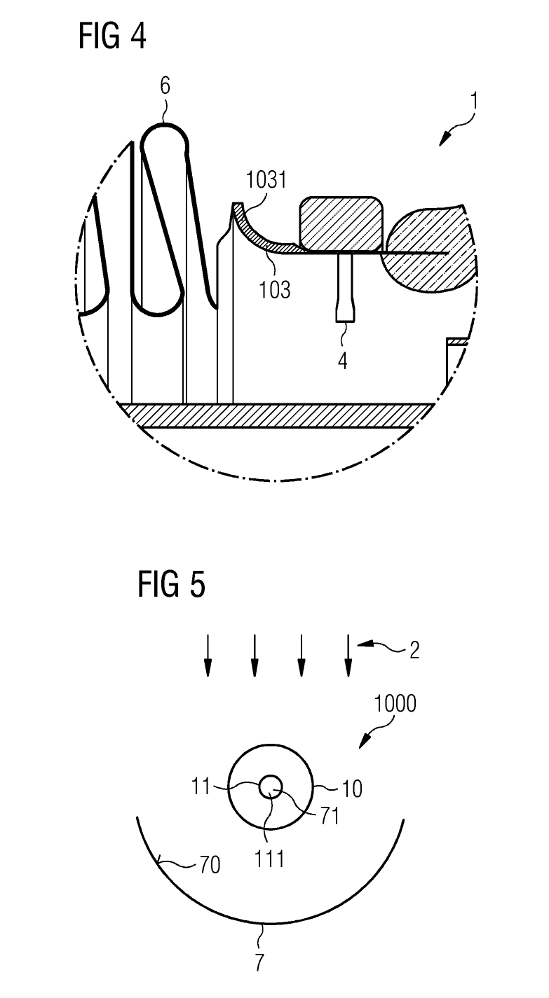

FIG. 4 shows a further part of the heat receiver tube of FIG. 1; and

FIG. 5 shows a cross section of a parabolic through collector with the heat receiver tube.

### DETAILED DESCRIPTION

Given is a heat receiver tube 1. The heat receiver tube 1 comprises a core tube 11 stainless steel. The core tube 11 comprises a core tube surface 112 with at least one solar energy absorptive coating for absorbing solar radiation 2 of the sunlight

In the core tube 11 a heat transfer fluid 111 can be located. The heat transfer fluid 111 is a thermo-oil. Alternatively the heat transfer fluid 111 is molten salt.

The enveloping tube 10 comprises an enveloping tube wall 101 out of glass. This enveloping tube wall is transparent for the solar radiation 2. The enveloping tube wall 101 comprises an inner enveloping tube surface 102, the external surface is coated by an AR layer (anti reflecting coating).

The core tube 11 and the enveloping tube 10 are coaxially arranged to each other. The core tube surface 112 and the inner enveloping tube surface 102 arranged face to face. By this an inner heat receiver tube space 12 results which is bordered by the core tube surface 112 and the inner enveloping tube surface 102.

The core tube 11 and the enveloping tube 10 are coaxially arranged to each other such that an inner heat receiver tube space 3 is formed which is bordered by the core tube surface 112 and the inner enveloping tube surface 102. At a front side 13 of the heat receiver tube 1 a dimension adapting device 6 with a flexible adapting device wall 60 for compensation of a thermally induced change of at least one dimension 12 of the heat receiver tube 1 is arranged. The dimension adapting device 6 are bellows 61 with a bellow walls 611.

The heat receiver tube comprises 1 at least one inlet port for pouring in of at least one inert gas into the inner heat receiver tube space. The inert gas is Xenon. In an alternative embodiment, the inert gas is Krypton. A partial pressure of the inert gas comprises 150 mbar.

First embodiment: The inlet port 4 is drilled into the glass tube wall 101 of the envelope tube 10 (FIGS. 1 and 2). The inlet port dimension 401 of the inlet port 4 is about 10 mm.

Second embodiment: the inlet port 4 is drilled into the bellows wall 611 of a bellows 61.

Third embodiment: The inlet port 4 is drilled into a heat receiver tube skirt 103 which covers (partly) the bellows 60 and the enveloping glass tube 10.

For the filling (pouring in) of the inert gas 5 through the inlet port 4 a sealing of the inlet port 4 is carried out with the aid of a sealing 41. The sealing 41 is an O-ring with elastomeric sealing material.

The heat receiver tube 1 is part of a solar collector 1000. The solar collector 1000 comprises at least one parabolic mirror 3 with a sunlight reflective surface 31. By the solar radiation reflecting surface 70 sunlight 2 is directed to the focal line 71 of the parabolic mirror 7. The concentrated sunlight is absorbed by the heat receiver tube 1 (FIG. 5).

The heat receiver tube 1 is arranged on the side of the incoming direct sunlight radiation 2.

The solar collector 1000 is used in a solar thermal power plant for converting solar energy into electrical energy. The heated heat transfer fluid is used to produce steam via a heat exchanger. The steam is driving a turbine, which is connected to a generator. The generator produces current (electrical energy).

Although the present invention has been described in detail with reference to the preferred embodiment, it is to be understood that the present invention is not limited by the disclosed examples, and that numerous additional modifications and variations could be made thereto by a person skilled in the art without departing from the scope of the invention.

It should be noted that the use of “a” or “an” throughout this application does not exclude a plurality, and “comprising” does not exclude other steps or elements. Also elements described in association with different embodiments may be combined. It should also be noted that reference signs in the claims should not be construed as limiting the scope of the claims.

1. A heat receiver tube for absorbing solar energy and for transferring absorbed solar energy to a heat transfer fluid which can be located inside of at least one core tube of the heat receiver tube, wherein
the at least one core tube comprises a core tube surface with at least one solar energy absorptive coating for absorbing solar radiation;
the at least one core tube is enveloped by at least one enveloping tube;
the at least one enveloping tube comprises at least one enveloping tube wall which is at least partly transparent for the solar radiation;
the at least one enveloping tube wall comprises at least one inner enveloping tube surface;
the at least one core tube and the enveloping tube are coaxially arranged to each other such that an inner heat receiver tube space is formed which is bordered by the core tube surface and the at least one inner enveloping tube surface; and
the heat receiver tube comprises at least one inlet port for pouring in of at least one inert gas into the inner heat receiver tube space.

2. The heat receiver tube according to claim 1, wherein the at least one inlet port comprises an inlet port dimension which is selected from the range between 1 mm and 20 mm.

3. The heat receiver tube according to claim 1, wherein the inner heat receiver tube space comprises the at least one inert gas.

4. The heat receiver according to claim 1, wherein the at least one inert gas is at least one noble gas which selected from the group consisting of Krypton and Xenon.

5. The heat receiver tube according to claim 3, wherein a partial pressure of the at least one inert gas in the inner heat receiver tube space is selected from the range between 5 mbar and 300 mbar.

6. The heat receiver tube according to claim 1, wherein the enveloping tube wall comprises glass.

7. The heat receiver tube according to claim 1, wherein the heat receiver tube comprises at least one dimension adapting device with a flexible adapting device wall for compensation of a thermally induced change of at least one dimension of the heat receiver tube.

8. The heat receiver tube according to claim 7, wherein the dimension adapting device comprises bellows and the flexible adapting device wall comprises a bellows wall.

9. The heat receiver tube according to claim 8, wherein the bellows are arranged at a front side of the heat receiver tube.

10. The heat receiver tube according to claim 7, wherein the enveloping tube and the dimension adapting device are covered by at least one heat receiver tube skirt with at least one heat receiver tube skirt wall.

11. The heat receiver tube according to claim 7, wherein the flexible adapting device wall and/or the heat receiver tube skirt wall comprise at least one metal.

12. The heat receiver tube according to claim 1, wherein the enveloping tube wall and/or the bellows wall and/or the heat receiver tube skirt wall comprise the inlet port.

13. A method for manufacturing a heat receiver tube with following steps:
a) providing of at least one precursor tube of at least one heat receiver tube and
b) arranging of at least one inlet port at the heat receiver tube for pouring in of at least one gas into the inner heat receiver tube space of the heat receiver tube.

14. The method according to claim 13, wherein after the arranging of the inlet port at the receiver tube a pouring of the gas into the heat receiver tube space though the inlet port is carried out, wherein the at least one gas is an inert gas.

15. The method according to claim 14, wherein after the pouring of the inert gas though the inlet port a sealing of the inlet port with the aid of a sealing is carried out.

16. The method according to claim 13, wherein the arranging of the inlet port comprises a drilling of a hole into at least one of the walls of the heat receiver tube.

17. A solar collector comprising
at least one mirror having a solar radiation reflecting mirror surface for directing the solar radiation to a focal line of the solar radiation reflecting mirror surface; and
at least one heat receiver tube according to claim 1 which is arranged in the focal line of the solar radiation reflecting mirror surface.

18. The solar collector according to claim 17, wherein the mirror is a parabolic mirror or a Fresnel minor.

19. A method for producing electricity by using the solar collector according to claim 17 in a solar thermal power plant for converting solar radiation into electrical energy, wherein an absorbing of the solar radiation is carried out with the aid of the solar collector.
